(19) United States
(12) Patent Application Publication
(10) Pub. No.: US 2025/0342471 A1
(43) Pub. Date: Nov. 6, 2025

(54) ACCOUNT VERIFICATION WITH MICRODEPOSITS

(71) Applicant: Plaid Inc., San Francisco, CA (US)

(72) Inventors: Allen CHEN, San Francisco, CA (US); Richard FALCON, New York, NY (US); Shaffer BOND, New York, NY (US); Trevor POTTINGER, Seattle, WA (US)

(21) Appl. No.: 18/652,116

(22) Filed: May 1, 2024

(51) Int. Cl. G06Q 20/40

(52) U.S. Cl. CPC G06Q 20/4014; G06Q 20/409

(57) ABSTRACT

In some implementations, a verification system may receive, from a user device, a request to validate an account. The verification system may initiate a microdeposit using an electronic rail, and the microdeposit may be associated with a human-readable description. The verification system may receive, from the user device, an indication of the human-readable description associated with the microdeposit. The verification system may therefore validate the account based on the indication.

### BACKGROUND

In order to improve security, verifying an account for a user may include performing a transaction with the account in addition to verifying information about the account. However, the transaction may increase latency.

### SUMMARY

Some implementations described herein relate to a system for account verification with microdeposits. The system may include one or more memories and one or more processors communicatively coupled to the one or more memories. The one or more processors may be configured to receive, from a user device, a request to validate an account. The one or more processors may be configured to initiate a microdeposit using an electronic rail, wherein the microdeposit is associated with a description that includes a sequence of characters set off from remaining characters in the description. The one or more processors may be configured to receive, from the user device, an indication of a code associated with the microdeposit. The one or more processors may be configured to validate the account based on the code matching the sequence of characters.

Some implementations described herein relate to a method of account verification with microdeposits. The method may include receiving, from a user device and at a validation system, a request to validate an account. The method may include initiating a microdeposit by the validation system and using an electronic rail, wherein the microdeposit is associated with a human-readable description. The method may include receiving, from the user device and at the validation system, an indication of the human-readable description associated with the microdeposit. The method may include validating the account by the validation system based on the indication.

Some implementations described herein relate to a non-transitory computer-readable medium that stores a set of instructions for account verification with microdeposits. The set of instructions, when executed by one or more processors of a device, may cause the device to receive an identifier associated with an account. The set of instructions, when executed by one or more processors of the device, may cause the device to initiate a microdeposit using the identifier and an electronic rail, wherein the microdeposit is initiated using a message that encodes a description with a sequence of characters set off from remaining characters in the description. The set of instructions, when executed by one or more processors of the device, may cause the device to transmit a prompt for a code associated with the microdeposit. The set of instructions, when executed by one or more processors of the device, may cause the device to receive, in response to the prompt, an indication of the code associated with the microdeposit. The set of instructions, when executed by one or more processors of the device, may cause the device to validate the account based on the code and the sequence of characters.

Some implementations described herein relate to a system for generating user interfaces (UIs) for account verification with microdeposits. The system may include one or more memories and one or more processors communicatively coupled to the one or more memories. The one or more processors may be configured to receive, using a first UI, information associated with an account. The one or more processors may be configured to output a second UI indicating that a microdeposit will be used. The one or more processors may be configured to receive, using a third UI, an indication of a code associated with the microdeposit. The one or more processors may be configured to transmit, to a remote server, the code in response to an interaction with the third UI.

Some implementations described herein relate to a method of generating UIs for account verification with microdeposits. The method may include receiving, at a verification system, a request to validate an account. The method may include outputting, to a user device, an indication that a microdeposit will be used. The method may include receiving, from the user device and using a UI, an indication of a code associated with the microdeposit. The method may include transmitting, from the verification system and to a remote server, an indication that the account is verified based on the indication of the code.

Some implementations described herein relate to a non-transitory computer-readable medium that stores a set of instructions for generating UIs for account verification with microdeposits. The set of instructions, when executed by one or more processors of a device, may cause the device to receive, using a first UI, an identifier associated with an account. The set of instructions, when executed by one or more processors of the device, may cause the device to receive, using a second UI, a type of the account. The set of instructions, when executed by one or more processors of the device, may cause the device to receive, using a third UI, an indication of a code associated with a microdeposit into the account. The set of instructions, when executed by one or more processors of the device, may cause the device to transmit, to a remote server, the code associated with the microdeposit.

Some implementations described herein relate to a system for generating UIs for account verification with microdeposits. The system may include one or more memories and one or more processors communicatively coupled to the one or more memories. The one or more processors may be configured to receive, using a first UI, information associated with an account. The one or more processors may be configured to output a second UI associated with authentication using credentials based on the information associated with the account. The one or more processors may be configured to output a third UI associated with authentication using microdeposits based on an interaction with the second UI. The one or more processors may be configured to transmit, to a remote server, an indication of a code associated with the microdeposit.

Some implementations described herein relate to a method of generating UIs for account verification with microdeposits. The method may include receiving, at a verification system, a request to validate an account. The method may include outputting, to a user device, instructions for a first UI associated with authentication using credentials based on information associated with the account. The method may include outputting, to the user device, instructions for a second UI associated with authentication using microdeposits based on an interaction with the first UI. The method may include transmitting, from the verification system and to a remote server, an indication of a code associated with the microdeposit.

Some implementations described herein relate to a non-transitory computer-readable medium that stores a set of instructions for generating UIs for account verification with microdeposits. The set of instructions, when executed by one or more processors of a device, may cause the device to receive, using a first UI, an identifier associated with an account. The set of instructions, when executed by one or more processors of the device, may cause the device to output a second UI associated with authentication using credentials based on machine learning model output associated with the account. The set of instructions, when executed by one or more processors of the device, may cause the device to output a third UI associated with authentication using microdeposits based on an interaction with the second UI. The set of instructions, when executed by one or more processors of the device, may cause the device to transmit, to a remote server, a verification of the account based on the authentication using microdeposits.

Some implementations described herein relate to a system for account verification with microdeposits. The system may include one or more memories and one or more processors communicatively coupled to the one or more memories. The one or more processors may be configured to receive, from a user device, a request to validate an account. The one or more processors may be configured to receive, from the user device, information associated with the account. The one or more processors may be configured to apply a machine learning model to the information associated with the account in order to determine how to validate the account. The one or more processors may be configured to selectively validate the account, automatically, using credentials, or using a microdeposit, based on output from the machine learning model.

Some implementations described herein relate to a method of account verification with microdeposits. The method may include receiving, at a verification system, an identifier associated with an account. The method may include transmitting, from the verification system and to a machine learning model, the identifier associated with the account in order to receive an indication of how to validate the account. The method may include selectively validating the account, automatically, using credentials, or using a microdeposit, based on the indication of how to validate the account.

Some implementations described herein relate to a non-transitory computer-readable medium that stores a set of instructions for account verification with microdeposits. The set of instructions, when executed by one or more processors of a device, may cause the device to receive, from a user device, information associated with the account. The set of instructions, when executed by one or more processors of the device, may cause the device to apply a machine learning model to the information associated with the account in order to receive an indication of how to validate the account. The set of instructions, when executed by one or more processors of the device, may cause the device to selectively validate the account, automatically, using credentials, or using a microdeposit, based on the indication of how to validate the account.

### BRIEF DESCRIPTION OF THE DRAWINGS

FIGS. 1A-1E are diagrams of an example implementation relating to account verification using microdeposits.

FIGS. 2A-2H are diagrams of example UIs relating to account verification using microdeposits.

FIG. 3 is a diagram of an example environment in which systems and/or methods described herein may be implemented.

FIG. 4 is a diagram of example components of one or more devices of FIG. 3.

FIGS. 5-8 are flowcharts of example processes relating to account verification with microdeposits.

### DETAILED DESCRIPTION

The following detailed description of example implementations refers to the accompanying drawings. The same reference numbers in different drawings may identify the same or similar elements.

In order to improve security, verifying an account for a user may include performing a transaction with the account in addition to verifying information about the account. However, the transaction may increase latency. Additionally, the account may be verified using an amount associated with the transaction. However, varying the amount only results in a limited set of possibilities, which decreases security by increasing chances of a bad actor guessing the amount and obtaining access to the account.

Some implementations described herein enable verifying accounts using descriptions associated with microdeposits. As a result, security is improved because the descriptions include a larger set of possibilities than varying amounts of the microdeposits. In some implementations, the microdeposits are associated with same-day delivery. Indeed, some implementations use immediate delivery for the microdeposits, which reduces latency in verifying the accounts. As used herein, “immediate” refers to a delay of only a few seconds or a few minutes at most, and no more than one hour.

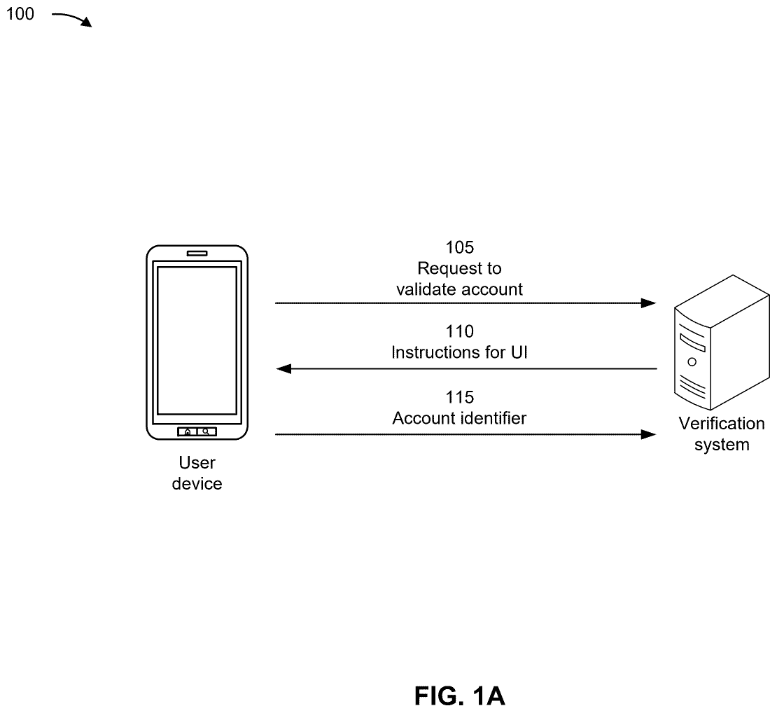

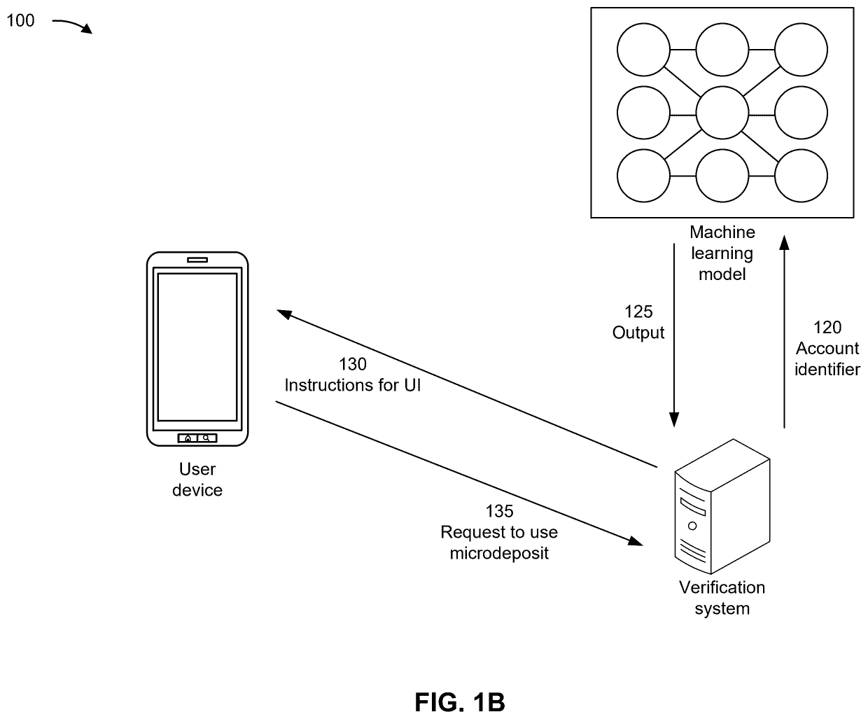

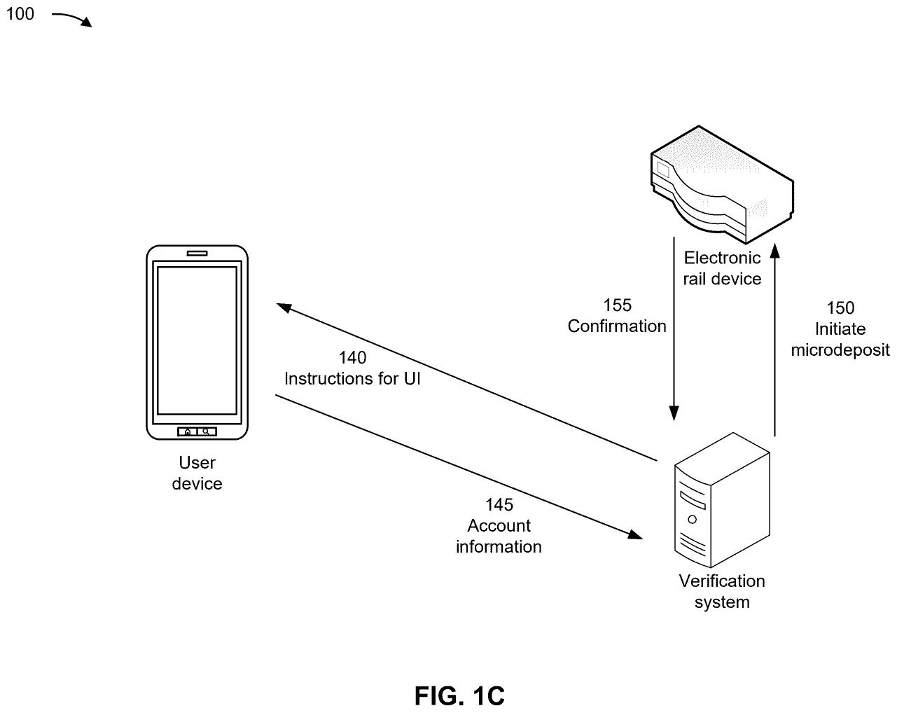

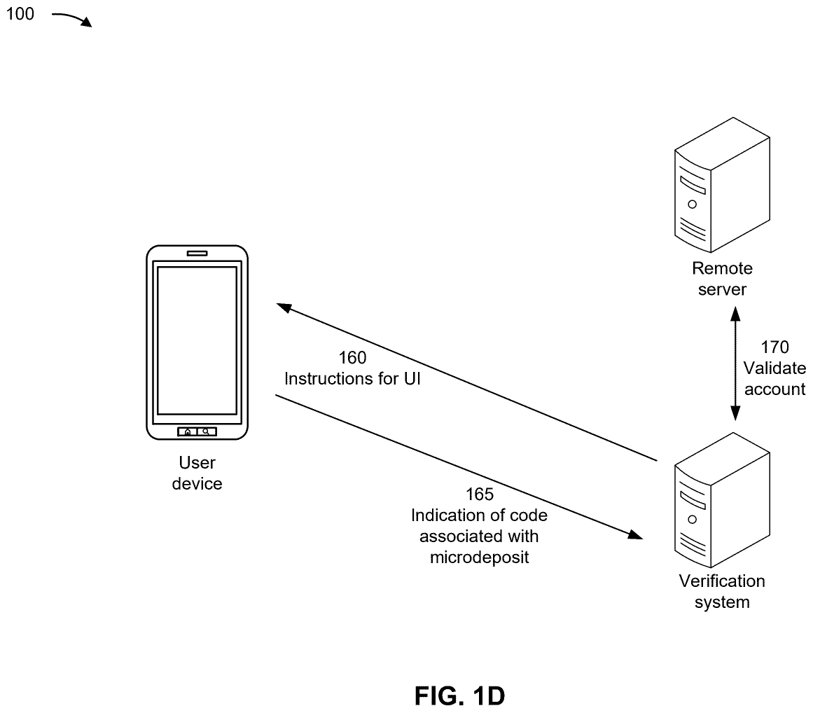

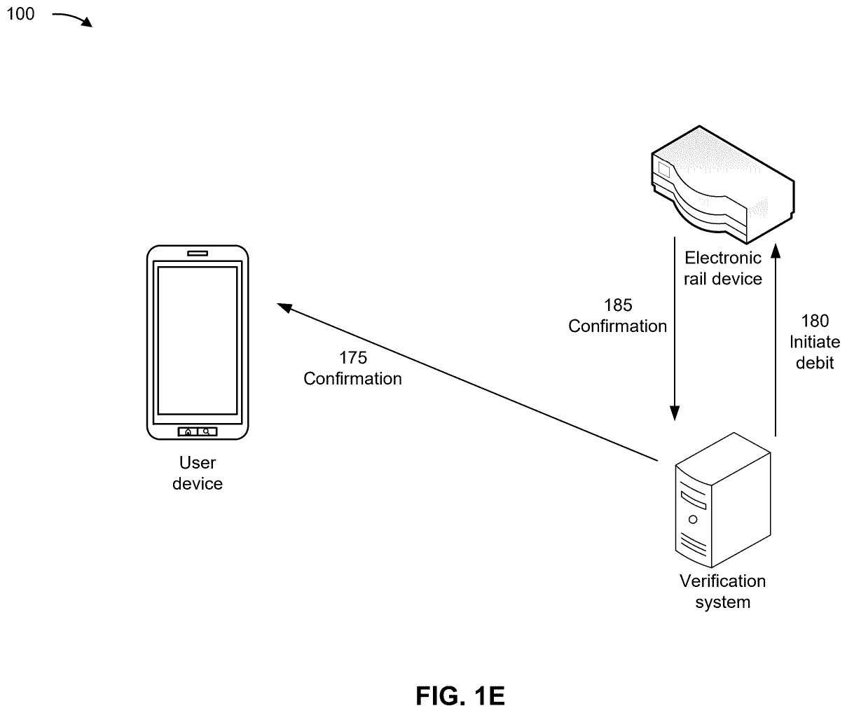

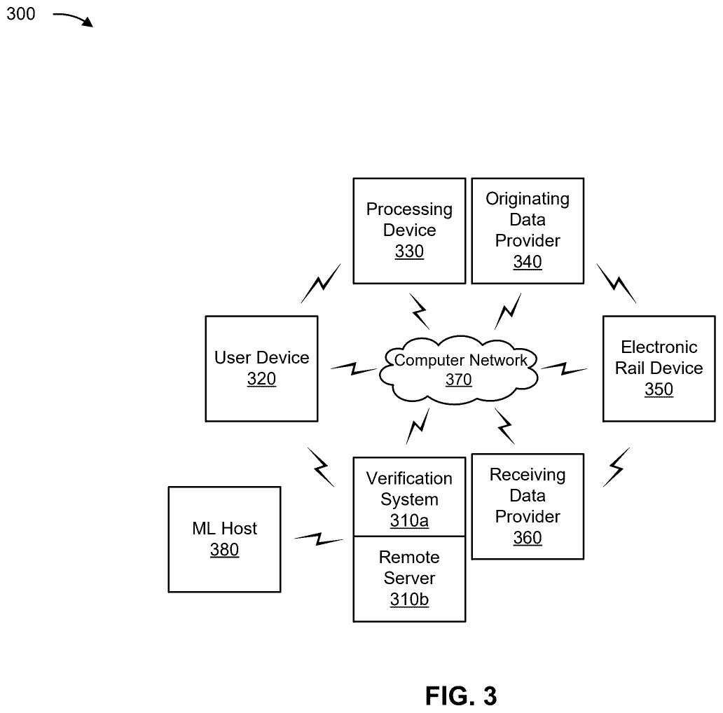

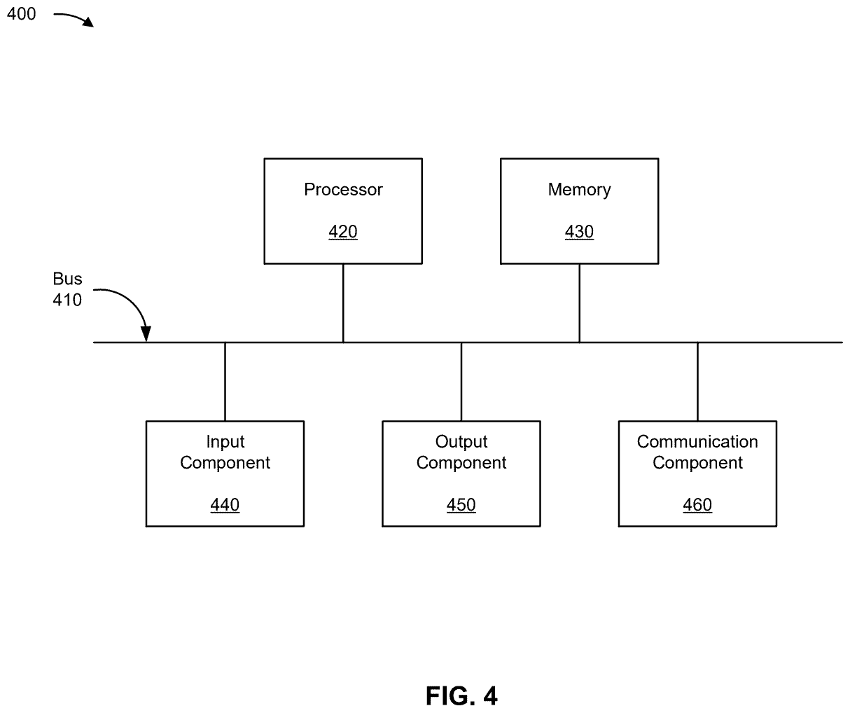

FIGS. 1A-1E are diagrams of an example 100 associated with account verification using microdeposits. As shown in FIGS. 1A-1E, example 100 includes a user device, a verification system, a machine learning (ML) model (e.g., provided by an ML host), an electronic rail device, and a remote server. These devices are described in more detail in connection with FIGS. 3 and 4.

As shown in FIG. 1A and by reference number 105, the user device may transmit, and the verification system may receive, a request to validate an account. The request may include a hypertext transfer protocol (HTTP) request, a file transfer protocol (FTP) request, and/or an application programming interface (API) call. In some implementations, a user of the user device may provide input (e.g., using an input component of the user device) that triggers the user device to transmit the request. For example, a web browser (or another type of application executed by the user device) may navigate to a website hosted by (or at least associated with) the verification system and provide a user interface (UI) to the user (e.g., using an output component of the user device). Accordingly, the user may interact with the UI to trigger the user device to transmit the indication. Alternatively, the web browser may navigate to a website hosted by (or at least associated with) a third-party system (e.g., the remote server or a different device) and provide a UI to the user (e.g., using an output component of the user device). Accordingly, the user may interact with the UI to trigger the user device to transmit the request to the third-party system, and the third-party system may forward the request to the verification system (e.g., directly by passing packets encoding the request to the verification system, or indirectly by decoding information from the request and encoding a new message to the verification system based on the information from the request).

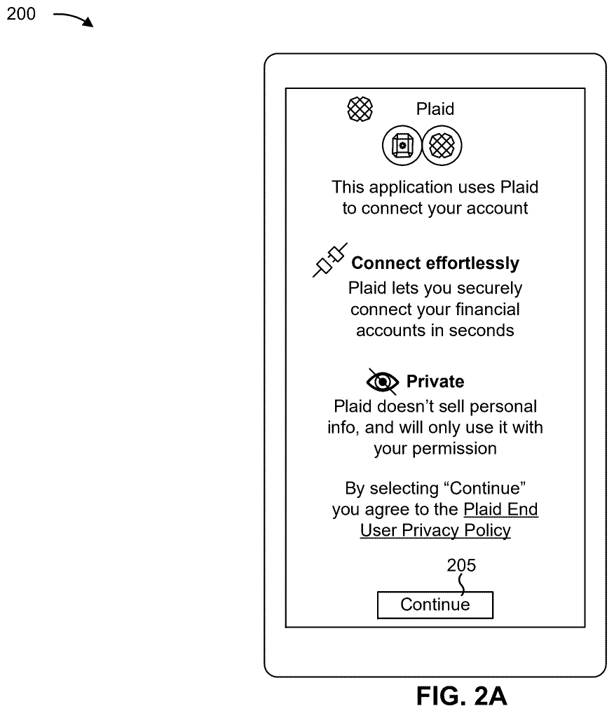

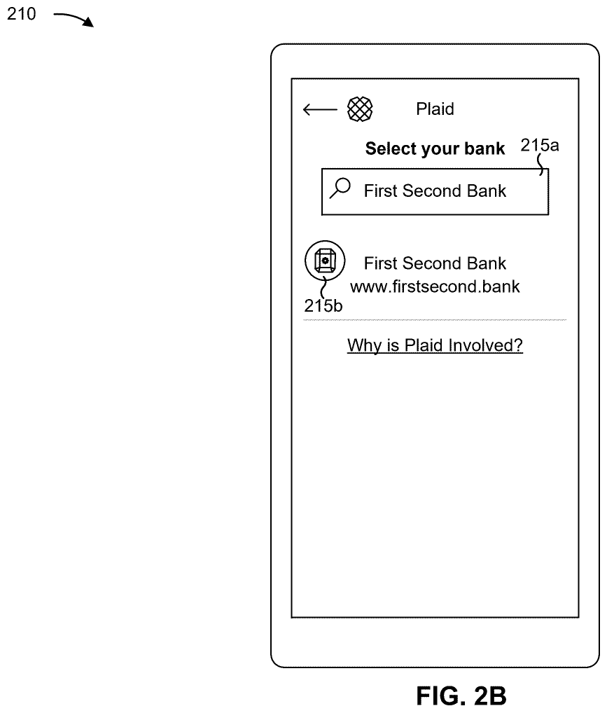

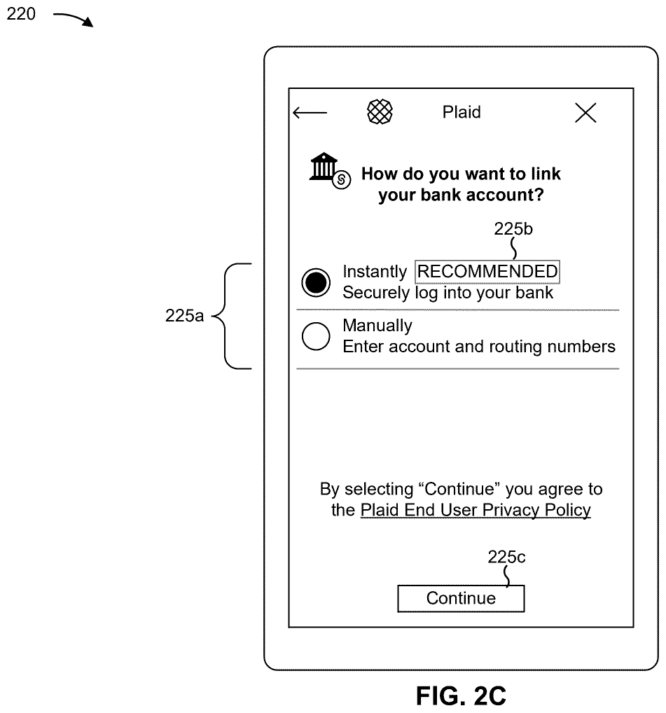

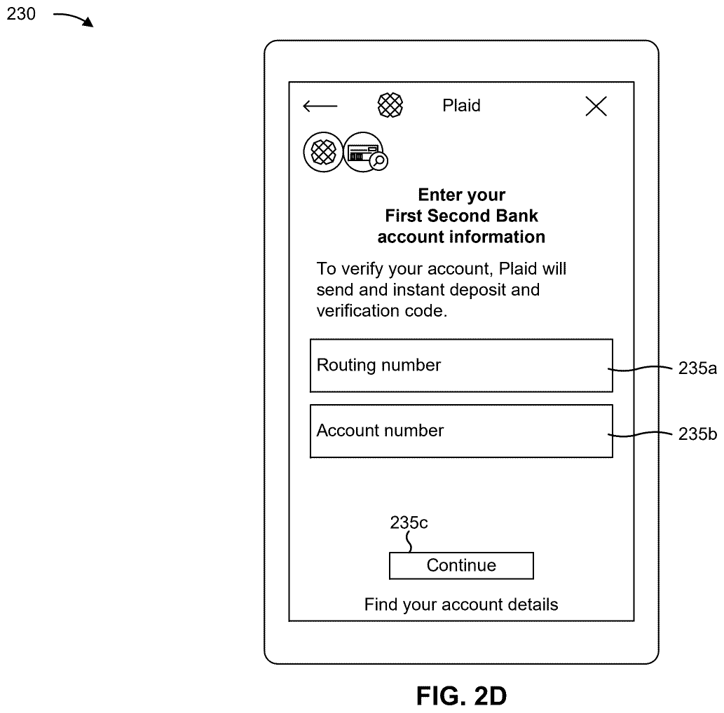

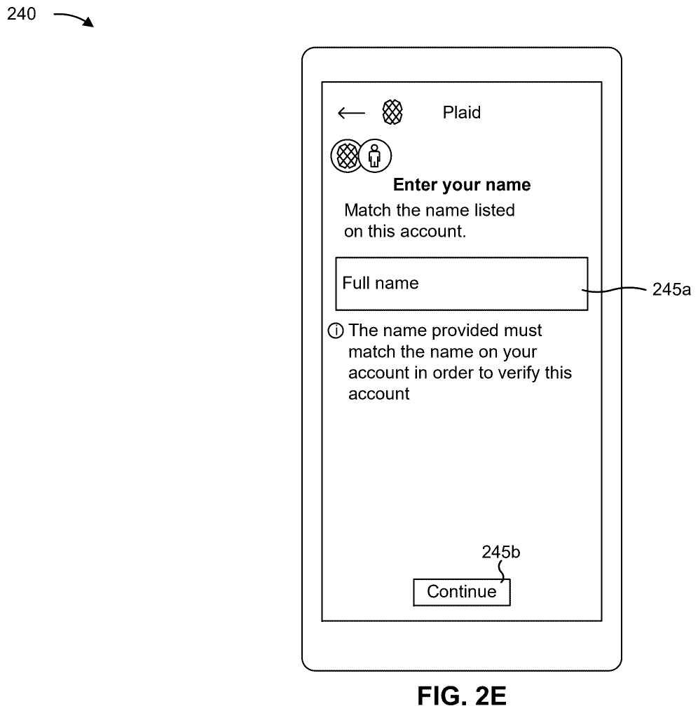

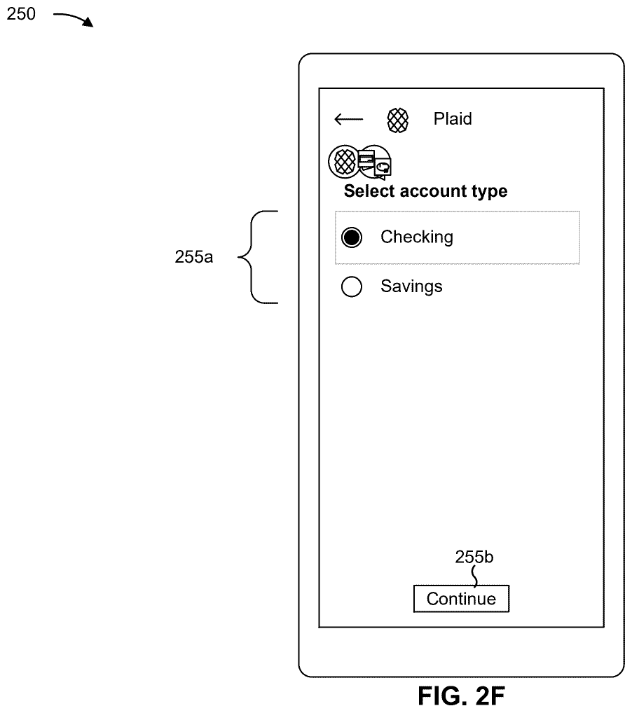

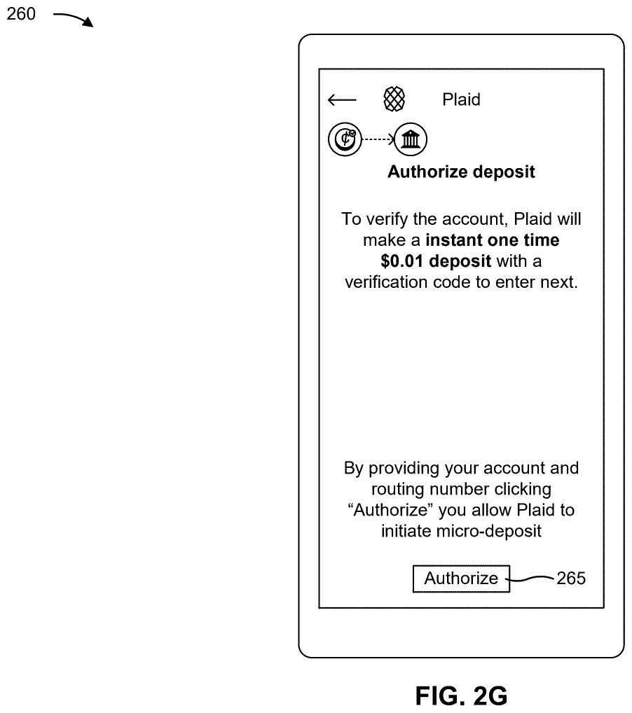

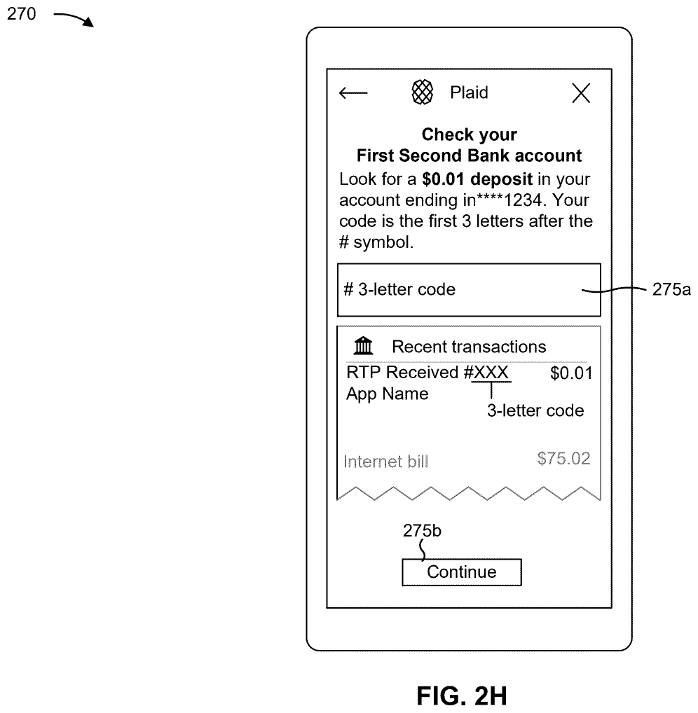

The UI may be as described in connection with FIG. 2A. The verification system may transmit, and the user device may receive, instructions for the UI (e.g., at least one UI), and therefore the request to validate the account may be received using the UI. For example, the user may interact with an interactive element of the UI, as described in connection with FIG. 2A, to trigger the user device to transmit the request.

As shown by reference number 110, the verification system may transmit, and the user device may receive, instructions for a UI. The UI may be as described in connection with FIG. 2B. The user device may output the UI (e.g., to the user and via an output component of the user device).

As shown by reference number 115, the user device may transmit, and the verification system may receive, an identifier associated with the account. The identifier may include a name of an institution associated with the account. Accordingly, the identifier may be received using an input element (e.g., at least one input element) of the UI described in connection with reference number 110. For example, the user may use a button of the UI, as described in connection with FIG. 2B, to indicate the name of the institution. Additionally, or alternatively, the identifier may include a routing number associated with the account. For example, the user may use a text box of the UI to indicate the routing number.

Although the example 100 describes the identifier as transmitted separately from the request, other examples may include the identifier as part of the request. For example, the request to validate the account may include the identifier associated with the account, such as a routing number, as described above. In another example, the request to validate the account may indicate an institution associated with the account, such as with a name of the institution, as described above. The identifier may be received using an input element (e.g., at least one input element) of a UI that is used to trigger the user device to transmit the request.

As shown in FIG. 1B, the verification system may determine to proceed with authentication using credentials. In some implementations, the verification system may use the identifier associated with the account to determine to proceed with authentication using credentials. For example, the verification system may map the identifier to an indication of how to validate the account. The verification system may use a data structure (e.g., a tabular structure, a graph structure, another type of relational data structure, a NoSQL structure, or another type of non-relational data structure) that stores indications of how to validate accounts in association with account identifiers.

In some implementations, and as shown in FIG. 1B, the verification system may use the ML model to determine to proceed with authentication using credentials. For example, the verification system may apply the ML model to the identifier in order to determine how to validate the account. The verification system may apply the ML model locally or, as shown by reference number 120, may provide the identifier to the ML model (e.g., via the ML host). For example, the verification system may transmit, and the ML host may receive, a request including the identifier. The ML model may be trained (e.g., by the ML host and/or a device at least partially separate from the ML host) using a labeled set of institutions, a labeled set of routing numbers, and/or a labeled set of account types (e.g., for supervised learning). Additionally, or alternatively, the ML model may be trained using unlabeled historical account verifications (e.g., for deep learning). In one example, the ML model may be configured to compare the identifier in the request to other identifiers and/or historical account verifications associated with the same identifier (e.g., in order to suggest how to validate the account). Additionally, or alternatively, the ML model may be configured to cluster the identifier in the request with other identifiers and/or historical account verifications.

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., existing sets of computer code). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the verification system (or the ML host), such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 125, the verification system may receive output from the ML model (e.g., from the ML host). The output may include an indication of how to validate the account. In some implementations, the indication may include a binary indication (e.g., a Boolean value, a bit, or another type of binary variable) that indicates authentication using credentials (e.g., by setting the variable to ‘TRUE’ or ‘1’) or authentication using microdeposits (e.g., by setting the variable to ‘FALSE’ or ‘0’). Additionally, or alternatively, the indication of how to validate the account may include a binary indication (e.g., a Boolean value, a bit, or another type of binary variable) that indicates whether the account can be validated automatically (e.g., by setting the variable to ‘TRUE’ or ‘1’) or should be validated using credentials and/or microdeposits (e.g., by setting the variable to ‘FALSE’ or ‘0’). For example, the ML model may determine that the account can be automatically validated without credentials or microdeposits based on a probability, of the identifier and/or additional information associated with the account being valid, satisfying a validation threshold. Additionally, or alternatively, the verification system may indicate that the verification system is not validating debitability (and/or another similar property) of the account, so the ML model may determine that authentication using credentials and/or microdeposits is unnecessary. In some implementations, the indication may be set to a selected value out of a plurality of preconfigured values (e.g., similar to a switch operation in C++). For example, the indication may be set to a first value to indicate automatic validation, a second value to indicate authentication using credentials, or a third value to indicate authentication using microdeposits. In another example, the indication may be set to a first value to indicate automatic validation, a second value to indicate authentication using credentials, a third value to indicate authentication using immediate microdeposits, or a fourth value to indicate authentication using slower microdeposits (e.g., same-day or slower).

As shown by reference number 130, the verification system may transmit, and the user device may receive, instructions for a UI. The UI may be associated with authentication using credentials. In some implementations, the verification system may transmit instructions for the UI associated with authentication using credentials, based on the identifier, as described above. For example, the verification system may determine, using information associated with the account, that the account is eligible for authentication using credentials and may output the instructions for UI based on the account being eligible for authentication using credentials. Additionally, or alternatively, as described above, the verification system may transmit instructions for the UI associated with authentication using credentials, based on the output from the machine learning model. The UI associated with authentication using credentials may be as described in connection with FIG. 2C. The user device may output the UI (e.g., to the user and via an output component of the user device).

In some implementations, the credentials may include a username and password (e.g., associated with the account). Additionally, or alternatively, the credentials may include a two-factor authorization (2FA) code (e.g., associated with the account). Accordingly, the UI may include an input element (e.g., at least one input element) associated with the credentials. For example, the UI may include a text box for the username, the password, and/or the 2FA code.

As shown by reference number 135, the user device may transmit, and the verification system may receive, a request for authentication using microdeposits. In some implementations, the user device may transmit the request in response to an interaction with the UI described above. For example, the UI may include a set of radio buttons (e.g., a first radio button associated with authentication using credentials and a second radio button associated with authentication using microdeposits), and the interaction may include selection of a radio button associated with authentication using microdeposits (e.g., the second radio button). As described in connection with FIG. 2C, the first radio button may be associated with a visual indication of recommendation. In another example, the UI may include an interactive element (e.g., a button), and the interaction may be with the interactive element.

As shown in FIG. 1C and by reference number 140, the verification system may transmit, and the user device may receive, instructions for a UI. The UI may be associated with authentication using microdeposits. For example, the verification system may transmit instructions for the UI associated with authentication using microdeposits, based on the interaction, as described above. The UI associated with authentication using microdeposits may be as described in connection with FIG. 2G. The user device may output the UI (e.g., to the user and via an output component of the user device). In some implementations, the verification system may determine, using information associated with the account, that the account is eligible for authentication using microdeposits and may output the instructions for UI based on the account being eligible for authentication using microdeposits. Accordingly, the user may be permitted to opt for authenticating using a microdeposits (e.g., using the interaction described above) only when the verification system determines that the account is eligible for authentication using microdeposits.

Although the example 100 is described in connection with the user opting for authentication using a microdeposit, the verification system may, more generally, selectively validate the account using credentials or a microdeposit (or even automatically, as described above). For example, the verification system may selectively validate the account using credentials or a microdeposit (or even automatically) based on the output from the machine learning model, as described above. In another example, the verification system may selectively validate the account using credentials or a microdeposit (or even automatically) based on the indication of how to validate the account, as described above. Therefore, whether the verification system transmits instructions for the UI associated with authentication using microdeposits or instructions for the UI associated with authentication using credentials (or neither) may depend on how the verification system determines to validate the account.

Additionally, or alternatively, the verification system may determine how to validate the account based on additional factors. For example, the verification system may select authentication using microdeposits based on an indication that debitability of the account should be tested. In another example, the verification system may select authentication using microdeposits based on an institution, associated with the account, refusing to allow authentication using credentials. Accordingly, the verification system may select authentication using microdeposits even if the machine learning model (and/or the data structure) described above recommends authentication using credentials.

As shown by reference number 145, the user device may transmit, and the verification system may receive, information associated with the account. In some implementations, the verification system may transmit, and the user device may receive, instructions for a UI (e.g., at least one UI), and therefore the information associated with the account may be received using the UI. The UI may be as described in connection with FIG. 2D, FIG. 2E, and/or FIG. 2F. For example, the user may interact with an interactive element of the UI, as described in connection with FIGS. 2D-2F, to trigger the user device to transmit the information. Additionally, or alternatively, the information may be received using an input element (e.g., at least one input element) of the UI. For example, the user may use a text box, as described in connection with FIG. 2D, to indicate a routing number and/or an account number. In another example, the user may use a text box, as described in connection with FIG. 2E, to indicate a name (e.g., of the user) associated with the account. In another example, the user may use a set of radio buttons, as described in connection with FIG. 2F, to indicate a type of the account (e.g., checking, savings, money market, mortgage, auto, or brokerage, among other examples).

In some implementations, the UI indicating that a microdeposit will be used, as described in connection with reference number 140, may be the same UI as is used to receive the information associated with the account. Alternatively, the UI including an indication that a microdeposit will be used, as described in connection with reference number 140, may be a different UI than the UI used to receive the information associated with the account. For example, the UI indicating that a microdeposit will be used may be as described in connection with FIG. 2G while the UI used to receive the information associated with the account may be as described in connection with FIG. 2D, FIG. 2E, and/or FIG. 2F.

Although the example 100 is described in connection with the information being received after determining how to validate the account, other examples may include the information being received beforehand. Accordingly, the verification system may use the information associated with the account to determine how to validate the account. For example, the verification system may use a data structure that stores indications of how to validate accounts in association with account information. In another example, the verification system may transmit, and the ML host may receive, a request including the information.

As shown by reference number 150, the verification system may initiate a microdeposit to the account (e.g., using the electronic rail device). The microdeposit may be associated with same-day delivery or even immediate delivery. For example, the verification system may initiate the microdeposit using an electronic rail, and the electronic rail may be associated with same-day delivery or even immediate delivery (e.g., as described in connection with FIG. 3). The verification system may initiate the microdeposit in response to input from the user device. For example, the input may include the information associated with the account and/or another type of interaction with a UI (e.g., with an interactive element of the UI, as described in connection with FIGS. 2D-2G).

In some implementations, the verification system may initiate the microdeposit using the identifier associated with the account. For example, the verification system may transmit, and the electronic rail device may receive, a message including the identifier. The microdeposit may further be associated with a description. For example, the message may encode the description associated with the microdeposit. The description may include a sequence of characters that are set off from remaining characters in the description. The sequence of characters may include a three-letter code, as shown in FIG. 2H. More generally, the sequence of characters may be set off using a leading character (e.g., at least one leading character). In some implementations, the sequence of characters may include the leading character (e.g., such that the sequence of characters in FIG. 2H is considered a four-character code). The leading character may include a pound symbol, as shown in FIG. 2H, or another type of symbol. Additionally, the sequence of characters may be set off using a trailing character (e.g., at least one trailing character). In some implementations, the sequence of characters may include the trailing character. The trailing character may include a space, as shown in FIG. 2H, or another type of symbol.

In some implementations, the description may include a code associated with the microdeposit. For example, the sequence of characters may include the code. Although code in FIG. 2H is shown with letters, other examples may include a numerical code or an alphanumeric code.

In some implementations, the microdeposit may be associated with a human-readable description. For example, the sequence of characters may include the human-readable description. Accordingly, the human-readable description may be a sequence of characters set off from a larger description associated with the microdeposit. As used herein, “human-readable” may refer to one or more symbols that can be naturally recognized by humans (e.g., due to trailing and leading symbols, as described above, and/or explanatory words before and/or after the code, among other examples). A human-readable code is distinguished from a “machine-readable” description, such as a run-on series of characters and/or a binary or hexadecimal code, among other examples.

As shown by reference number 155, the electronic rail device may transmit, and the verification system may receive, a confirmation that the microdeposit was submitted and/or is complete. For example, the electronic rail device may transmit, and the verification system may receive, the confirmation in response to the message from the verification system that initiated the microdeposit.

The verification system may transmit, and the user device may receive, a prompt for the code associated with the microdeposit. For example, as shown in FIG. 1D and by reference number 160, the verification system may transmit, and the user device may receive, instructions for a UI. The UI may be as described in connection with FIG. 2H. The user device may output the UI (e.g., to the user and via an output component of the user device).

As shown by reference number 165, the user device may transmit, and the verification system may receive, an indication of the code associated with the microdeposit (e.g., an indication of the human-readable description associated with the microdeposit). The indication may be received using an input element (e.g., at least one input element) of the UI. For example, the user may use a text box of the UI, as described in connection with FIG. 2H, to indicate the code. The UI may indicate one or more surrounding characters associated with the code, as shown in FIG. 2H. In some implementations, the input element may be pre-populated with a leading character (e.g., at least one leading character) and/or a trailing character (e.g., at least one trailing character). Additionally, or alternatively, the input element may be configured to accept only letters or accept only numbers. Additionally, or alternatively, the input element may be configured with a maximum quantity of symbols. Any configurations that limit entry into the input element conserves power and processing resources, at the verification system and/or the remote server, that otherwise would have been spent on rejecting incorrect entry into the input element.

In some implementations, the user may interact with an interactive element of the UI, as described in connection with FIG. 2H, to trigger the user device to transmit the indication. Additionally, or alternatively, the verification system may communicate with the remote server based on interaction with the interactive element of the UI. For example, as shown by reference number 170, the verification system may validate the account with the remote server. As described in connection with FIG. 3, the verification system may be at least partially separate from the remote server (e.g., logically, physically, and/or virtually). Alternatively, the verification system may be integrated with the remote server. Accordingly, communication between the verification system and the remote server may constitute communication between different applications of a same computing device (or a same set of computing devices).

In some implementations, the verification system may transmit, and the remote server may receive, (an indication of) the code associated with the microdeposit (e.g., based on interaction with the interactive element of the UI, as described above). Therefore, the remote server may validate the account based on the code (received from the verification system) and the sequence of characters (associated with the microdeposit). For example, the remote server may validate the account based on the code matching the sequence of characters (e.g., a perfect match or a fuzzy match, such as a match ignoring case and/or ignoring extra spaces, among other examples). Therefore, the remote server may transmit, and the verification system may receive, a confirmation that the account was verified. The remote server may transmit, and the verification system may receive, the confirmation in response to (the indication of) the code associated with the microdeposit.

Additionally, or alternatively, the verification system may validate the account based on the code (received from the user device) and the sequence of characters (associated with the microdeposit). For example, the verification system may validate the account based on the code matching the sequence of characters, as described above. Therefore, the verification system may transmit, and the remote server may receive, a verification of the account (based on the authentication using microdeposits). For example, the verification system may transmit, and the remote server may receive, an indication that the account is verified (based on the indication of the code from the user device).

As shown in FIG. 1E and by reference number 175, the verification system may transmit, and the user device may receive, a confirmation of the verification of the account. For example, the verification system may transmit, and the user device may receive, instructions for a UI including the confirmation. The user device may output the UI (e.g., to the user and via an output component of the user device).

In some implementations, the verification system may additionally initiate a debit from the account. For example, as shown by reference number 180, the verification system may initiate a debit of the microdeposit (e.g., using the electronic rail device). The debit may be associated with an automated clearing house (ACH) network, as described in connection with

FIG. 3. In some implementations, the verification system may initiate the debit after transmitting the verification of the account (e.g., to the remote server, as described above) and/or after transmitting the confirmation of the verification (e.g., to the user device, as described above).

In some implementations, the verification system may transmit, and the electronic rail device may receive, a message to initiate the debit. For example, the message may include a national automated clearing house association (NACHA) file. As shown by reference number 185, the electronic rail device may transmit, and the verification system may receive, a confirmation that the debit was submitted and/or complete. For example, the electronic rail device may transmit, and the verification system may receive, the confirmation in response to the message from the verification system that initiated the debit.

By using techniques as described in connection with FIGS. 1A-1E, the verification system may validate the account using the description associated with the microdeposit. As a result, security is improved because the description is associated with a larger set of possibilities than a set of possibilities associated with an amount of the microdeposit. Additionally, the verification system may use the electronic rail device that is associated with same-day or even immediate delivery, which reduces latency in validating the account.

As indicated above, FIGS. 1A-1E are provided as an example. Other examples may differ from what is described with regard to FIGS. 1A-1E.

FIGS. 2A-2H are diagrams of example UIs associated with account verification using microdeposits. The example UIs of FIGS. 2A-2H may be shown by a user device (e.g., in response to instructions from a verification system). These devices are described in more detail in connection with FIGS. 3 and 4.

Example UI 200 of FIG. 2A may be used to submit a request to validate an account. As shown in FIG. 2A, the example UI 200 may include an interactive element, such as a button 205. The button 205 may be used to trigger the user device to transmit the request (e.g., to the verification system).

Example UI 210 of FIG. 2B may be used to submit an identifier associated with the account. As shown in FIG. 2B, the example UI 210 may include an input element, such as a text box 215a. The text box 215a may be used to provide the identifier to the user device (e.g., to transmit to the verification system). Additionally, or alternatively, as shown in FIG. 2B, the example UI 210 may include an interactive element, such as a button 215b. The button 215b may be used to trigger the user device to transmit the identifier (e.g., to the verification system). In a combinatory example, a user may enter (at least a portion of) a query into the text box 215a, the button 215b may be generated based on a response to the query, and the user may trigger the device to transmit an identifier, associated with the button 215b, by interacting with the button 215b.

Example UI 220 of FIG. 2C may be used to select between authentication using microdeposits and authentication using credentials. As shown in FIG. 2C, the example UI 220 may include an input element, such as a set of radio buttons 225a. The set of radio buttons 225a may include a first radio button associated with authentication using credentials and associated with a visual indication 225b of recommendation (e.g., based on output from a machine learning model, as described in connection with FIG. 1B). The set of radio buttons 225a may further include a second radio button associated with authentication using microdeposits. As further shown in FIG. 2C, the example UI 220 may include an interactive element, such as a button 225c. The button 225c may be used to trigger the user device to transmit a request for authentication using microdeposits or a request for authentication using credentials (e.g., to the verification system).

Example UI 230 of FIG. 2D may be used to submit information associated with the account. As shown in FIG. 2D, the example UI 230 may include a first input element, such as a text box 235a. The text box 235a may be used to provide a routing number to the user device (e.g., to transmit to the verification system). The example UI 230 may further include a second input element, such as a text box 235b. The text box 235b may be used to provide an account number to the user device (e.g., to transmit to the verification system). As further shown in FIG. 2D, the example UI 230 may include an interactive element, such as a button 235c. The button 235c may be used to trigger the user device to transmit the information (e.g., to the verification system).

Example UI 240 of FIG. 2E may be used to submit information associated with the account. As shown in FIG. 2E, the example UI 240 may include an input element, such as a text box 245a. The text box 245a may be used to provide a name (e.g., associated with the account) to the user device (e.g., to transmit to the verification system). As further shown in FIG. 2E, the example UI 240 may include an interactive element, such as a button 245b. The button 245b may be used to trigger the user device to transmit the information (e.g., to the verification system).

Example UI 250 of FIG. 2F may be used to submit information associated with the account. As shown in FIG. 2F, the example UI 250 may include an input element, such as a set of radio buttons 255a. The set of radio buttons 225a may be used to indicate a type of the account. As further shown in FIG. 2F, the example UI 250 may include an interactive element, such as a button 255b. The button 255b may be used to trigger the user device to transmit the information (e.g., to the verification system).

Example UI 260 of FIG. 2G may be used to indicate authentication using a microdeposit. As further shown in FIG. 2G, the example UI 260 may include an interactive element, such as a button 265. The button 265 may be used to trigger the verification system to initiate the microdeposit.

Example UI 270 of FIG. 2H may be used to indicate a code associated with the microdeposit. As shown in FIG. 2H, the example UI 270 may include an input element, such as a text box 275a. The text box 275a may be used to provide the code (e.g., associated with the microdeposit) to the user device (e.g., to transmit to the verification system). As further shown in FIG. 2H, the example UI 270 may include an interactive element, such as a button 275b. The button 275b may be used to trigger the user device to transmit the indication of the code (e.g., to the verification system).

As indicated above, FIGS. 2A-2H are provided as examples. Other examples may differ from what is described with regard to FIGS. 2A-2H.

FIG. 3 is a diagram of an example environment 300 in which systems and/or methods described herein may be implemented. As shown in FIG. 3, environment 300 may include a verification system 310a, a remote server 310b, a user device 320, a processing device 330, an originating data provider 340, an electronic rail device 350, a receiving data provider 360, a computer network 370, and/or an ML host 380. Devices of environment 300 may interconnect via wired connections and/or wireless connections.

The verification system 310a may include one or more devices capable of receiving, generating, storing, processing, and/or providing information associated with accounts, as described elsewhere herein. The verification system 310a may validate accounts (e.g., using credentials and/or microdeposits, as described herein). The verification system 310a may include a communication device and/or a computing device. For example, the verification system 310a may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The verification system 310a may communicate with one or more other devices of environment 300, as described elsewhere herein.

The remote server 310b may include one or more devices capable of receiving, generating, storing, processing, and/or providing information associated with accounts, as described elsewhere herein. The remote server 310b may receive and store account information from data partners (e.g., the originating data provider 340 and/or the receiving data provider 360). The remote server 310b may include a communication device and/or a computing device. For example, the remote server 310b may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The remote server 310b may communicate with one or more other devices of environment 300, as described elsewhere herein. As shown in FIG. 3, the verification system 310a and the remote server 310b may be at least partially integrated (e.g., physically, logically, and/or virtually). Alternatively, the verification system 310a and the remote server 310b may be separate from each other and communicate via the computer network 370.

The user device 320 may include one or more devices capable of facilitating verification of an account (e.g., validation of an account). The user device 320 may include a communication device and/or a computing device. For example, the user device 320 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 320 may include one or more input components and/or one or more output components to facilitate interaction with and/or authorization from a user (e.g., an owner or accountholder). Example input components of the user device 320 include a network interface card (NIC), a keyboard, a touchscreen, a mouse, and/or a radio frequency (RF) signal reader (e.g., a near-field communication (NFC) reader). Example output components of the user device 320 include the NIC, a display, and/or a speaker. The user device 320 may communicate with one or more other devices of environment 300, as described elsewhere herein.

The processing device 330 may include one or more devices capable of processing, authorizing, and/or facilitating a transaction. For example, the processing device 330 may include one or more servers and/or computing hardware (e.g., in a cloud computing environment or separate from a cloud computing environment) configured to receive and/or store information associated with processing an electronic transaction (e.g., a NACHA file or another type of ACH file, among other examples). The processing device 330 may process an event (e.g., a transaction) by directing transaction information to the originating data provider 340. The processing device 330 may communicate with one or more other devices of environment 300, as described elsewhere herein.

The originating data provider 340 may include one or more devices capable of receiving, generating, storing, processing, and/or providing information associated with accounts, as described elsewhere herein. The originating data provider 340 may process events (e.g., transactions) associated with an account managed by the originating data provider 340 (e.g., based on NACHA files or other types of ACH files received from the processing device 330). The originating data provider 340 may include a communication device and/or a computing device. For example, the originating data provider 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The originating data provider 340 may communicate with one or more other devices of environment 300, as described elsewhere herein.

The electronic rail device 350 may include one or more devices capable of receiving, processing, storing, routing, and/or providing traffic (e.g., NACHA files and/or other types of ACH files) in a manner described herein. For example, the electronic rail device 350 may include a router, a switch, a hub, a bridge, a reverse proxy, a server (e.g., a proxy server, a cloud server, or a data center server), and/or a similar device. In some implementations, the electronic rail device 350 may be associated with The Clearing House® (TCH) Electronic Payments Network (EPN) or the Federal Reserve Bank Automated Clearing House (FedACH).

Additionally, or alternatively, the electronic rail device 350 may be associated with a same-day ACH network. Additionally, or alternatively, the electronic rail device 350 may be associated with immediate or instant deposits (e.g., a real-time payments (RTP) processing network or the Federal Reserve's FedNow service, among other examples). In some implementations, the electronic rail device 350 may be a virtual device implemented by one or more computing devices of a cloud computing environment or a data center. The electronic rail device 350 may forward NACHA files and/or other types of ACH files from the originating data provider 340 to the receiving data provider 360. In some implementations, the electronic rail device 350 may forward the files to another ACH network device for eventual routing to the receiving data provider 360. The electronic rail device 350 may communicate with one or more other devices of environment 300, as described elsewhere herein.

The receiving data provider 360 may include one or more devices capable of receiving, generating, storing, processing, and/or providing information associated with accounts, as described elsewhere herein. The receiving data provider 360 may process events (e.g., transactions) associated with an account managed by the receiving data provider 360 (e.g., based on NACHA files or other types of ACH files received from the electronic rail device 350). The receiving data provider 360 may include a communication device and/or a computing device. For example, the receiving data provider 360 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The receiving data provider 360 may communicate with one or more other devices of environment 300, as described elsewhere herein.

The computer network 370 may include one or more wired and/or wireless networks. For example, the computer network 370 may include a cellular network, a public land mobile network, a local area network, a wide area network, a metropolitan area network, a telephone network, a private network, the Internet, and/or a combination of these or other types of networks. The computer network 370 enables communication among the devices of environment 300.

The ML host 380 may include one or more devices capable of receiving, generating, storing, processing, and/or providing information associated with machine learning models, as described elsewhere herein. The ML host 380 may include a communication device and/or a computing device. For example, the ML host 380 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 380 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with account verification using microdeposits. The device 400 may correspond to a verification system 310a, a remote server 310b, a user device 320, a processing device 330, an originating data provider 340, an electronic rail device 350, a receiving data provider 360, and/or an ML host 380. In some implementations, a verification system 310a, a remote server 310b, a user device 320, a processing device 330, an originating data provider 340, an electronic rail device 350, a receiving data provider 360, and/or an ML host 380 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

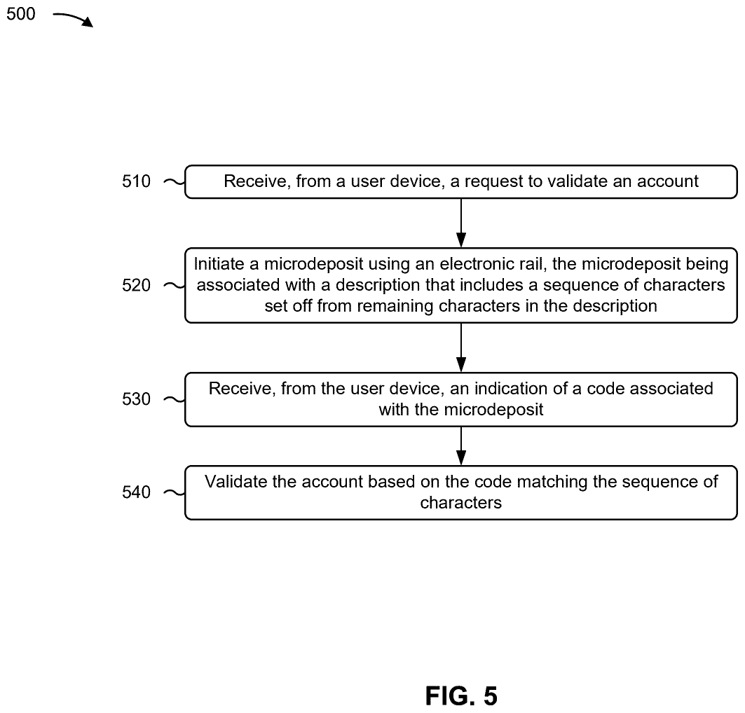

FIG. 5 is a flowchart of an example process 500 associated with account verification with microdeposits. In some implementations, one or more process blocks of FIG. 5 may be performed by a verification system 310a. In some implementations, one or more process blocks of FIG. 5 may be performed by another device or a group of devices separate from or including the verification system 310a, such as a remote server 310b, a user device 320, a processing device 330, an originating data provider 340, an electronic rail device 350, a receiving data provider 360, and/or an ML host 380. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, a request to validate an account (block 510). For example, the verification system 310a (e.g., using processor 420, memory 430, and/or communication component 460) may receive, from a user device, a request to validate an account, as described above in connection with reference number 105 of FIG. 1A. The request may include an HTTP request, an FTP request, and/or an API call. In some implementations, the request may include an identifier associated with the account (e.g., in a header and/or as an argument).

As further shown in FIG. 5, process 500 may include initiating a microdeposit using an electronic rail, the microdeposit being associated with a description that includes a sequence of characters set off from remaining characters in the description (block 520). For example, the verification system 310a (e.g., using processor 420, memory 430, and/or communication component 460) may initiate a microdeposit using an electronic rail, the microdeposit being associated with a description that includes a sequence of characters set off from remaining characters in the description, as described above in connection with reference number 150 of FIG. 1C. For example, the verification system 310a may transmit, to an electronic rail device, a message to initiate the microdeposit. The message may include the identifier associated with the account and/or the description associated with the microdeposit.

As further shown in FIG. 5, process 500 may include receiving, from the user device, an indication of a code associated with the microdeposit (block 530). For example, the verification system 310a (e.g., using processor 420, memory 430, and/or communication component 460) may receive, from the user device, an indication of a code associated with the microdeposit, as described above in connection with reference number 165 of FIG. 1D. The indication may be received using at least one input element of a UI. For example, the verification system 310a may transmit, to the user device, instructions for a UI including a text box for indicating the code, as described in connection with FIG. 2H.

As further shown in FIG. 5, process 500 may include validating the account based on the code matching the sequence of characters (block 540). For example, the verification system 310a (e.g., using processor 420 and/or memory 430) may validate the account based on the code matching the sequence of characters, as described above in connection with reference number 170 of FIG. 1D. The match may be a perfect match or a fuzzy match (e.g., a match ignoring case and/or ignoring extra spaces, among other examples).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and/or FIGS. 2A-2H.

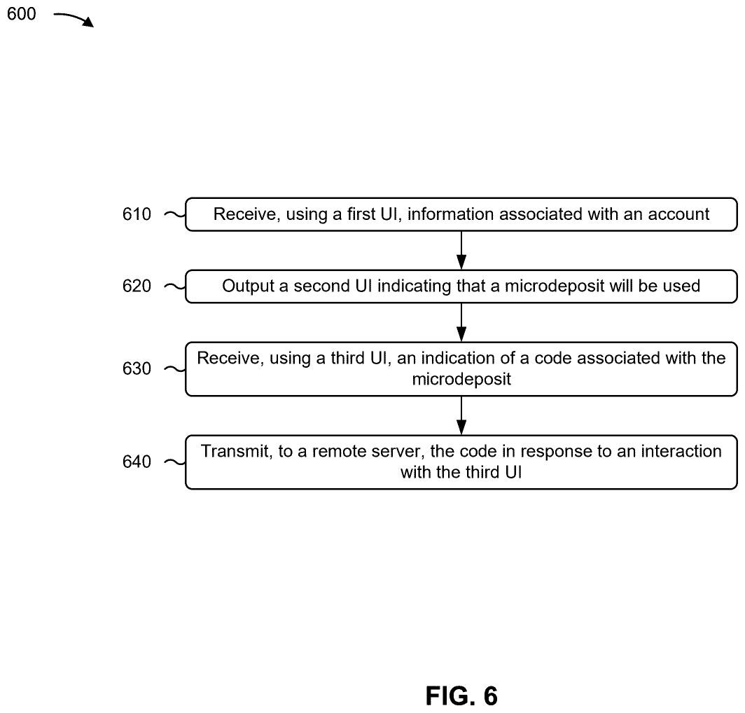

FIG. 6 is a flowchart of an example process 600 associated with account verification with microdeposits. In some implementations, one or more process blocks of FIG. 6 may be performed by a user device 320. In some implementations, one or more process blocks of FIG. 6 may be performed by another device or a group of devices separate from or including the user device 320, such as a verification system 310a, a remote server 310b, a processing device 330, an originating data provider 340, an electronic rail device 350, a receiving data provider 360, and/or an ML host 380. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include receiving, using a first UI, information associated with an account (block 610). For example, the user device 320 (e.g., using processor 420, memory 430, input component 440, and/or communication component 460) may receive, using a first UI, information associated with an account, as described above in connection with reference number 145 of FIG. 1C. The first UI may be as described in connection with FIG. 2D, FIG. 2E, and/or FIG. 2F. For example, a user of the user device 320 may use a text box, as described in connection with FIG. 2D, to indicate a routing number and/or an account number. In another example, the user of the user device 320 may use a text box, as described in connection with FIG. 2E, to indicate a name (e.g., of the user) associated with the account. In another example, the user of the user device 320 may use a set of radio buttons, as described in connection with FIG. 2F, to indicate a type of the account (e.g., checking, savings, money market, mortgage, auto, or brokerage, among other examples).

As further shown in FIG. 6, process 600 may include outputting a second UI indicating that a microdeposit will be used (block 620). For example, the user device 320 (e.g., using processor 420, memory 430, output component 450, and/or communication component 460) may output a second UI indicating that a microdeposit will be used, as described above in connection with reference number 140 of FIG. 1C. The second UI may be as described in connection with FIG. 2G.

As further shown in FIG. 6, process 600 may include receiving, using a third UI, an indication of a code associated with the microdeposit (block 630). For example, the user device 320 (e.g., using processor 420, memory 430, input component 440, and/or communication component 460) may receive, using a third UI, an indication of a code associated with the microdeposit, as described above in connection with reference number 165 of FIG. 1D. The user of the user device 320 may use a text box of the third UI, as described in connection with FIG. 2H, to indicate the code. The third UI may indicate one or more surrounding characters associated with the code, as shown in FIG. 2H.

As further shown in FIG. 6, process 600 may include transmitting, to a remote server, the code in response to an interaction with the third UI (block 640). For example, the user device 320 (e.g., using processor 420, memory 430, and/or communication component 460) may transmit, to a remote server, the code in response to an interaction with the third UI, as described above in connection with reference number 165 of FIG. 1D or reference number 170 of FIG. 1D. The remote server may be the verification system or may be separate from the verification system.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1E and/or FIGS. 2A-2H.

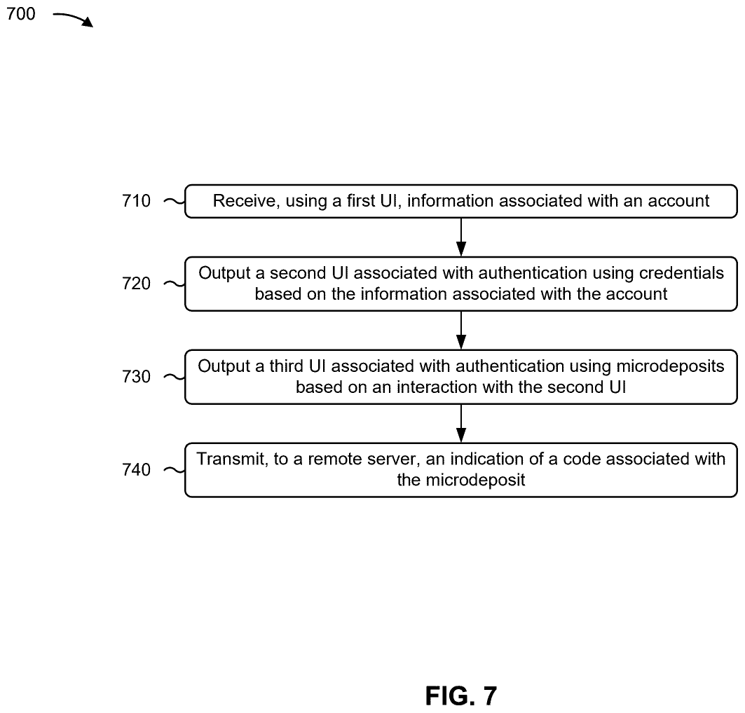

FIG. 7 is a flowchart of an example process 700 associated with account verification with microdeposits. In some implementations, one or more process blocks of FIG. 7 may be performed by a user device 320. In some implementations, one or more process blocks of FIG. 7 may be performed by another device or a group of devices separate from or including the user device 320, such as a verification system 310a, a remote server 310b, a processing device 330, an originating data provider 340, an electronic rail device 350, a receiving data provider 360, and/or an ML host 380. Additionally, or alternatively, one or more process blocks of FIG. 7 may be performed by one or more components of the device 400, such as processor 420, memory 430, input component 440, output component 450, and/or communication component 460.

As shown in FIG. 7, process 700 may include receiving, using a first UI, information associated with an account (block 710). For example, the user device 320 (e.g., using processor 420, memory 430, input component 440, and/or communication component 460) may receive, using a first UI, information associated with an account, as described above in connection with reference number 145 of FIG. 1C. The first UI may be as described in connection with FIG. 2D, FIG. 2E, and/or FIG. 2F. For example, a user of the user device 320 may use a text box, as described in connection with FIG. 2D, to indicate a routing number and/or an account number. In another example, the user of the user device 320 may use a text box, as described in connection with FIG. 2E, to indicate a name (e.g., of the user) associated with the account. In another example, the user of the user device 320 may use a set of radio buttons, as described in connection with FIG. 2F, to indicate a type of the account (e.g., checking, savings, money market, mortgage, auto, or brokerage, among other examples).

As further shown in FIG. 7, process 700 may include outputting a second UI associated with authentication using credentials based on the information associated with the account (block 720). For example, the user device 320 (e.g., using processor 420, memory 430, output component 450, and/or communication component 460) may output a second UI associated with authentication using credentials based on the information associated with the account, as described above in connection with reference number 130 of FIG. 1B. The second UI may be as described in connection with FIG. 2C. For example, the second UI may include a set of radio buttons (e.g., a first radio button associated with authentication using credentials and a second radio button associated with authentication using microdeposits). Additionally, or alternatively, the second UI may include at least one input element associated with the credentials (e.g., a username and password and/or a 2FA code, among other examples).

As further shown in FIG. 7, process 700 may include outputting a third UI associated with authentication using microdeposits based on an interaction with the second UI (block 730). For example, the user device 320 (e.g., using processor 420, memory 430, output component 450, and/or communication component 460) may output a third UI associated with authentication using microdeposits based on an interaction with the second UI, as described above in connection with reference number 140 of FIG. 1C. The third UI may be as described in connection with FIG. 2G. The interaction may include selection of a radio button associated with authentication using microdeposits (e.g., the second radio button).

As further shown in FIG. 7, process 700 may include transmitting, to a remote server, an indication of a code associated with the microdeposit (block 740). For example, the user device 320 (e.g., using processor 420, memory 430, and/or communication component 460) may transmit, to a remote server, an indication of a code associated with the microdeposit, as described above in connection with reference number 165 of FIG. 1D or reference number 170 of FIG. 1D. The remote server may be the verification system or may be separate from the verification system.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1E and/or FIGS. 2A-2H.

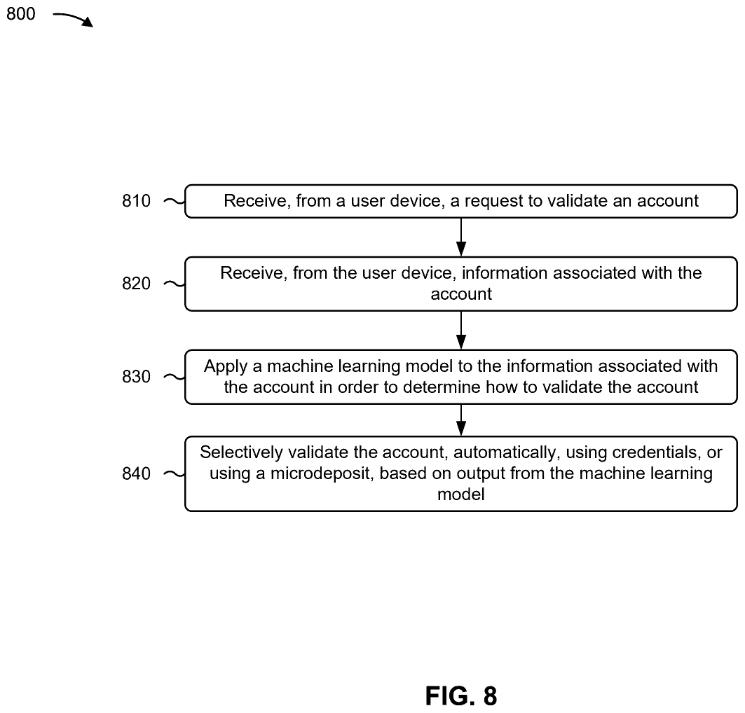

FIG. 8 is a flowchart of an example process 800 associated with account verification with microdeposits. In some implementations, one or more process blocks of FIG. 8 may be performed by a verification system 310a. In some implementations, one or more process blocks of FIG. 8 may be performed by another device or a group of devices separate from or including the verification system 310a, such as a remote server 310b, a user device 320, a processing device 330, an originating data provider 340, an electronic rail device 350, a receiving data provider 360, and/or an ML host 380. Additionally, or alternatively, one or more process blocks of FIG. 8 may be performed by one or more components of the device 400, such as processor 420, memory 430, input component 440, output component 450, and/or communication component 460.

As shown in FIG. 8, process 800 may include receiving, from a user device, a request to validate an account (block 810). For example, the verification system 310a (e.g., using processor 420, memory 430, and/or communication component 460) may receive, from a user device, a request to validate an account, as described above in connection with reference number 105 of FIG. 1A. The request may include an HTTP request, an FTP request, and/or an API call. In some implementations, the request may include an identifier associated with the account (e.g., in a header and/or as an argument).

As further shown in FIG. 8, process 800 may include receiving, from the user device, information associated with the account (block 820). For example, the verification system 310a (e.g., using processor 420, memory 430, and/or communication component 460) may receive, from the user device, information associated with the account, as described above in connection with reference number 145 of FIG. 1C. The indication may be received using at least one input element of a UI. For example, the verification system 310a may transmit, to the user device, instructions for a UI including a text box for indicating the information, as described in connection with FIG. 2D or FIG. 2E. Additionally, or alternatively, the verification system 310a may transmit, to the user device, instructions for a UI including a set of radio buttons for indicating the information, as described in connection with FIG. 2F.

As further shown in FIG. 8, process 800 may include applying a machine learning model to the information associated with the account in order to determine how to validate the account (block 830). For example, the verification system 310a (e.g., using processor 420 and/or memory 430) may apply a machine learning model to the information associated with the account in order to determine how to validate the account, as described above in connection with FIG. 1C. The machine learning model may output, and the verification system 310a may receive, an indication of how to validate the account. In some implementations, the indication may be a binary indication (e.g., a Boolean value, a bit, or another type of binary variable) that indicates authentication using credentials (e.g., by setting the variable to ‘TRUE’ or ‘1’) or authentication using microdeposits (e.g., by setting the variable to ‘FALSE’ or ‘0’). Alternatively, the indication may be set to a selected value out of a plurality of preconfigured values (e.g., similar to a switch operation in C++).

As further shown in FIG. 8, process 800 may include selectively validating the account, automatically, using credentials, or using a microdeposit, based on output from the machine learning model (block 840). For example, the verification system 310a (e.g., using processor 420 and/or memory 430) may selectively validate the account, automatically, using credentials, or using a microdeposit, based on output from the machine learning model, as described above in connection with FIG. 1C. Therefore, whether the verification system 310a transmits instructions for a UI associated with authentication using microdeposits or instructions for a UI associated with authentication using credentials (or neither) may depend on the output from the machine learning model.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel. The process 800 is an example of one process that may be performed by one or more devices described herein. These one or more devices may perform one or more other processes based on operations described herein, such as the operations described in connection with FIGS. 1A-1E and/or FIGS. 2A-2H.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for account verification with microdeposits, the system comprising:
one or more memories; and
one or more processors, communicatively coupled to the one or more memories, configured to:
receive, from a user device, a request to validate an account;
initiate a microdeposit using an electronic rail, wherein the microdeposit is associated with a description that includes a sequence of characters set off from remaining characters in the description;
receive, from the user device, an indication of a code associated with the microdeposit; and
validate the account based on the code matching the sequence of characters.

2. The system of claim 1, wherein the sequence of characters includes a human-readable description.

3. The system of claim 1, wherein the sequence of characters comprises a three-letter code.

4. The system of claim 1, wherein the sequence of characters includes a leading character.

5. The system of claim 4, wherein the leading character comprises a pound symbol.

6. The system of claim 1, wherein the request to validate the account includes an identifier associated with the account.

7. The system of claim 1, wherein the request to validate the account indicates an institution associated with the account.

8. The system of claim 1, wherein the electronic rail is associated with immediate delivery.

9. A method of account verification with microdeposits, comprising:
receiving, from a user device and at a validation system, a request to validate an account;
initiating a microdeposit by the validation system and using an electronic rail, wherein the microdeposit is associated with a human-readable description;
receiving, from the user device and at the validation system, an indication of the human-readable description associated with the microdeposit; and
validating the account by the validation system based on the indication.

10. The method of claim 9, further comprising:
transmitting, to the user device, instructions for at least one user interface (UI),
wherein the request to the validate the account is received using the at least one UI.

11. The method of claim 9, wherein the human-readable description comprises a sequence of characters set off from a larger description associated with the microdeposit.

12. The method of claim 11, wherein the sequence of characters are set off using at least one leading character.

13. The method of claim 12, wherein the at least one leading character includes a pound symbol.

14. The method of claim 11, wherein the sequence of characters are set off using at least one trailing character.

15. The method of claim 14, wherein the at least one trailing character includes a space.

16. A non-transitory computer-readable medium storing a set of instructions for account verification with microdeposits, the set of instructions comprising:
one or more instructions that, when executed by one or more processors of a device, cause the device to:
receive an identifier associated with an account;
initiate a microdeposit using the identifier and an electronic rail, wherein the microdeposit is initiated using a message that encodes a description with a sequence of characters set off from remaining characters in the description;
transmit a prompt for a code associated with the microdeposit;
receive, in response to the prompt, an indication of the code associated with the microdeposit; and
validate the account based on the code and the sequence of characters.

17. The non-transitory computer-readable medium of claim 16, wherein the one or more instructions, that cause the device to receive the identifier, cause the device to:
transmit instructions for a user interface (UI) with at least one input element; and
receive the identifier using the at least one input element.

18. The non-transitory computer-readable medium of claim 16, wherein the one or more instructions, that cause the device to transmit the prompt, cause the device to:
transmit instructions for a user interface (UI) with an input element,
wherein the indication of the code is received using the input element.

19. The non-transitory computer-readable medium of claim 16, wherein the one or more instructions, when executed by the one or more processors of the device, cause the device to:
initiate a debit of the microdeposit in response to validating the account.

20. The non-transitory computer-readable medium of claim 16, wherein the electronic rail is associated with immediate delivery.
